(19) United States
(12) Patent Application Publication
(10) Pub. No.: US 2017/0024726 A1
(43) Pub. Date: Jan. 26, 2017

(54) ELECTRONIC WALLET

(71) Applicant: HCL Technologies Limited, Uttar Pradesh (IN)

(72) Inventor: Jasbir Singh DHALIWAL, Noida (IN)

(21) Appl. No.: 15/178,559

(22) Filed: Jun. 9, 2016

(30) Foreign Application Priority Data
Jul. 22, 2015 (IN) 2227/DEL/2015

(51) Int. Cl. G06Q 20/36; G06Q 20/40

(52) U.S. Cl. CPC G06Q 20/363; G06Q 20/3674; G06Q 20/405

(57) ABSTRACT

Disclosed is an electronic wallet that may comprise a biometric authentication module for authenticating an owner of the electronic wallet. The owner may be authenticated by verifying authentication credentials received from the owner. The electronic wallet further comprises a scanner configured to scan one or more currency notes inserted or withdrawn for determine an amount of the one or more currency notes present in the electronic wallet. The electronic wallet further comprises a wireless communication means for establishing a communication channel between the electronic wallet and a communication device. The electronic wallet further comprises a demagnetization means for demagnetizing a snip of a financial instrument present in the electronic wallet based upon occurrence of at least one of the predefined events thereby rendering the financial instrument useless in order to avoid misuse of the electronic wallet.

### CROSS-REFERENCE TO RELATED APPLICATIONS AND PRIORITY

The present application claims benefit from Indian Complete Patent Application No. 2227/DEL/2015, filed on Jul. 22 2015, the entirety of which is hereby incorporated by reference.

### TECHNICAL FIELD

The present subject matter described herein, in general, relates to, an electronic wallet, and more particularly relates to the electronic wallet for securing a financial instrument placed in the electronic wallet.

### BACKGROUND

It has been observed that people used to place currency notes and financial instruments, such as a credit card and a debit card, in a wallet. In addition to the currency notes and the financial instruments, people further used to keep important documents in the wallet such as Driving License (DL), Permanent Account Number (PAN) Card etc. As the theft of wallets has been increased considerably in the past few years, this increases the risk of misuse of the financial instrument either online or at Point of Sale (POS) terminal or recovers the important documents. Thus, it becomes important for the owner to take utmost care of his/her wallet.

It has been further observed that sometimes people are unaware of the cash balance present in their wallet. As a result, they are not able to timely withdraw the cash from financial institutions, including ATMs and/or Banks etc., results in arising of difficult situations for the owner especially in areas where only cash is accepted. In addition to the above, a related concern is that the people are not able to predict appropriate amount of cash required and therefore tend to withdraw more or less than the optimal amount required for a particular period of time.

### SUMMARY

Before the present systems and methods, are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application. This summary is provided to introduce concepts related to an electronic wallet and the concepts are further described below in the detailed description. This summary is not intended to identify essential features of the claimed subject matter nor is it intended for use in determining or limiting the scope of the claimed subject matter.

In one implementation, an electronic wallet is disclosed. The electronic wallet comprises a biometric authentication module for authenticating an owner of the electronic wallet. The owner may be authenticated by verifying authentication credentials received from the owner. In one aspect, the authentication credentials may be verified by a centralized server communicatively coupled with the electronic wallet. The electronic wallet further comprises a scanner configured to scan one or more currency notes inserted or withdrawn from the electronic wallet. In one aspect, the one or more currency notes are scanned for determining an amount of the one or more currency notes present in the electronic wallet. The electronic wallet further comprises a wireless communication means for establishing a communication channel between the electronic wallet and a communication device. The communication channel may be established in order to notify the owner, on the communication device, based upon occurrence of at least one of predefined events. The electronic wallet further comprises demagnetization means for demagnetizing a strip of a financial instrument present in the electronic wallet based upon occurrence of at least one of the predefined events thereby rendering the financial instrument useless in order to avoid misuse of the electronic wallet.

### BRIEF DESCRIPTION OF THE DRAWINGS

The foregoing detailed description of embodiments is better understood when read in conjunction with the appended drawings. For the purpose of illustrating the disclosure, example constructions of the disclosure is shown in the present document; however, the disclosure is not limited to the specific methods and apparatus disclosed in the document and the drawings.

The detailed description is given with reference to the accompanying figures. In the figures, the left-most digit(s) of a reference number identifies the figure in which the reference number first appears. The same numbers are used throughout the drawings to refer like features and components.

FIG. 1 illustrates a network implementation of an electronic wallet communicatively coupled with a centralized server, in accordance with an embodiment of the present subject matter.

FIG. 2 illustrates biometric authentication module of the electronic wallet, in accordance with an embodiment of the present subject matter.

FIG. 3 illustrates a plurality of components embedded in the electronic wallet, in accordance with an embodiment of the present subject matter.

FIG. 4 illustrates the centralized server, in accordance with an embodiment of the present subject matter.

### DETAILED DESCRIPTION

Some embodiments of this disclosure, illustrating all its features, will now be discussed in detail. The words “comprising,” “having,” “containing ,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the exemplary, systems and methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

An electronic wallet for securing a financial instrument placed the electronic wallet and analyzing spending pattern of the owner are disclosed. Examples of the financial instrument may include, but not limited to, a credit card or a debit card. The invention envisages the electronic wallet with capabilities like data connectivity with internet or a centralized server, via Subscriber Identity Module (SIM), and location tracking via a Global Positioning System (GPS) sensor. In order to avoid the problems identified in the existing art, the electronic wallet comprises a plurality of components embedded in the electronic wallet. The plurality of components, either alone or in combination, facilitate to prevent the electronic wallet from theft or thereby prevent the misuse of the financial instrument present in the electronic wallet. In one aspect, the plurality of components may include, but not limited to, a biometric authentication module, a scanner, a wireless communication means, and demagnetization means.

In order to prevent the electronic wallet from theft, the biometric authentication module facilitates to authenticate the owner of the electronic wallet. In one aspect, the biometric authentication module comprises a plurality of biometric sensors including, but not limited to, a finger print sensor, a retina sensor, a heartbeat sensor, and an image capturing unit. In one embodiment, the owner may be authenticated upon verifying retina, finger print, heartbeat, or gesture, of the owner, using the plurality of biometric sensors respectively.

Further, the electronic wallet comprises the scanner configured to scan one or more currency notes inserted or withdrawn for determining an amount of the one or more currency notes present in the electronic wallet. The electronic wallet further comprises wireless communication means for establishing a communication channel between the electronic wallet and a communication device. The communication device may include, but not limited to, a smart watch, a smart band, and a smart communication device. In one aspect, the communication channel may be established in order to notify the owner, on the communication device, based upon occurrence of at least one of predefined events. The electronic wallet further comprises the demagnetization means for demonetizing a strip of a financial instrument present in the electronic wallet based upon occurrence of at least one of the predefined events thereby rendering the financial instrument useless in order to avoid misuse of the electronic wallet.

In addition to the above, the electronic wallet may be communicatively coupled with the centralized server. In one aspect, the centralized server comprises an analytics engine that performs analysis on historical data, comprising the spending pattern of the owner, along with other data comprising GPS location of the owner, location of financial institution located within a predefined range of the owner. In one aspect, the analysis may be performed to notify, via the communication device, the owner to withdraw an amount from the financial institution when the amount of the one or more currency notes is less than a predefined threshold amount.

Thus, based on the aforementioned description, the electronic wallet facilitate to secure the credit card or the debit card placed the electronic wallet and predict the spending pattern of the owner based on analysis performed by the analytics engine.

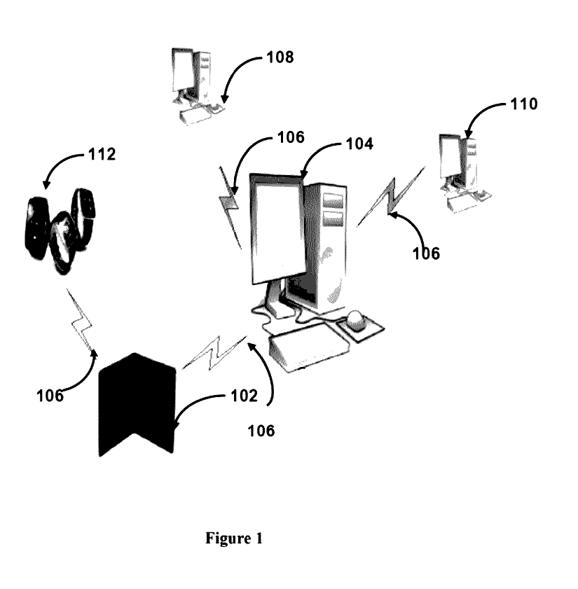

Referring now to FIG. 1, a network implementation 100 of an electronic wallet 102 is disclosed. In one aspect, the electronic wallet 102 may be communicatively coupled with a centralized server 104. It may be understood that the centralized server 104 may be implemented in a variety of computing systems, such as a laptop computer, a desktop computer, a notebook, a workstation, a mainframe computer, a server, a network server, a cloud-based computing environment. It will be understood that the centralized server 106 may be accessed by multiple users through one or more user devices hereinafter referred to as a first server 108 and a second server 110. It may be understood that the first server 108 belongs to a financial institution authorized to issue a financial instrument such as a credit card or a debit card. The second server 110, on the other hand, belongs to law enforcing agencies, such as Police authorities, that are notified by the centralized server 104 in ease of theft or misuse of the financial instrument.

In one implementation, the electronic wallet 102 is further communicatively coupled with one or more communication devices 112-1, 112-2 . . . 112-N, collectively referred to as a communication device 112. Examples of the communication device 104 may include, but are not limited to, a smart band, a smart watch, a smart phone, a portable computer, a personal digital assistant, a handheld device, and a workstation. It may be understood that the communication device 112 and the centralized server 104 are communicatively coupled to the electronic wallet 102 through a network 106.

In one implementation, the network 106 may be a wireless network, a wired network or a combination thereof. The network 106 can be implemented as one of the different types of networks, such as 2G, 3G, intranet, local area network (LAN), wide area network (WAN), the internet, and the like. In one implementation, the electronic wallet 102 uses a Constrained Application Protocol (CoAP) for communicating with the centralized server 106. In one aspect, the CoAP may be used to optimize the battery usage of the electronic wallet 106. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

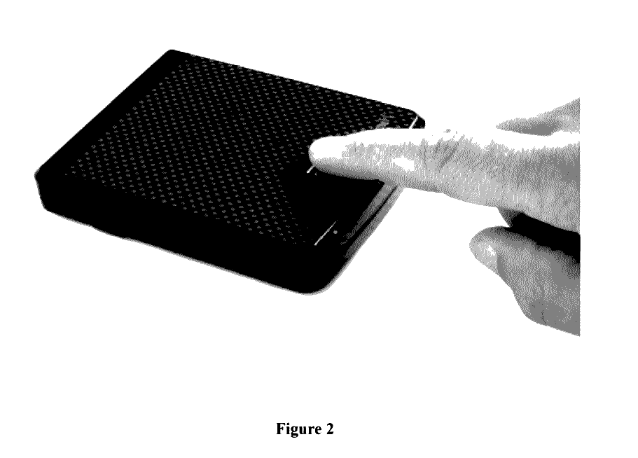

Referring now to FIG. 2, the electronic device 102 comprises a biometric authentication module as illustrated in the FIG. 2. In one aspect, the biometric authentication module comprises as plurality of biometric sensors including, but not limited to, a finger print sensor, a retina sensor, a heartbeat sensor, and an image capturing unit. In order to authenticate the owner, the biometric authentication module receives authentication credentials from an owner of the electronic wallet 102. The authentication credentials may be received in form of finger print, retina, heartbeat, or gesture. Upon receiving the authentication credentials, the authentication credentials ma be transmitted to the centralized server 106 for verifying the authenticity of the owner. Upon authenticating the authentication credentials, the owner is allowed to access the electronic wallet 102.

In order to elucidate the aforementioned functioning of the biometric authentication module, consider the biometric authentication module receives finger print of the owner by using the finger print sensor, as shown in the FIG. 2. The finger print may then be transmitted to the centralized server 104. The centralized server 104 may then compares the finger print with a pre-registered finger print of the owner. If the finger print is matched with the pre-registered finger print, the owner is allowed to access the electronic wallet 102. On the other hand, if the finger print is not matched with the pre-registered finger print, the owner is not allowed to access the electronic wallet 102. At the same instance, when the finger print is not matched with the pre-registered finger print, the centralized server 104 further transmits a notification on a first server 108 and a second server 110. The first server 108 is associated to issuer agencies of the financial instrument and the second server 110 is associated to law enforcing agencies. The notification transmitted to the first server 108 indicates that the electronic wallet 102 has been tried to access by an unauthorized person. Upon receiving the notification, the issuer agencies may take precautionary measures in order to prevent the access by the unauthorized person. Simultaneously, the notification transmitted to the second server 110 alerts the law enforcing agencies to take immediate action in order to prevent the access of the electronic wallet 102 by the unauthorized person. Thus, in this manner, the electronic wallet 102 may be prevented from theft and thereby misuse of the financial instrument.

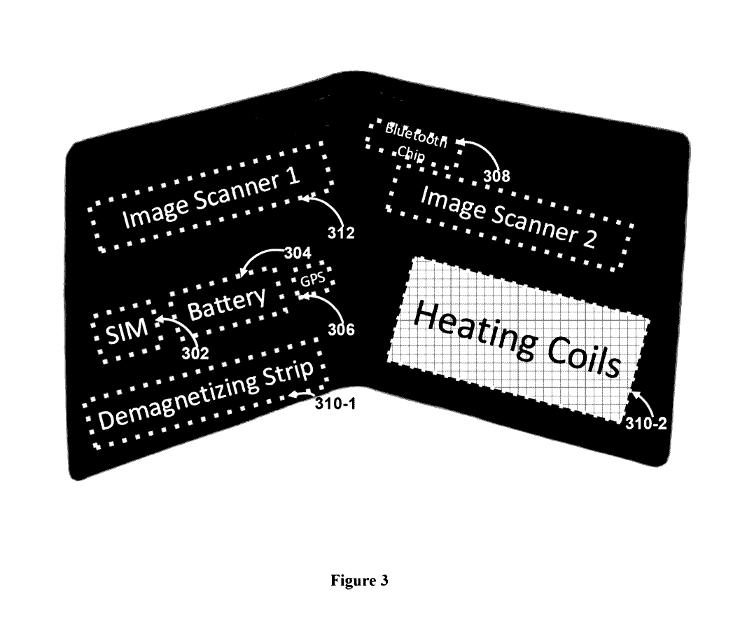

Now referring to FIG. 3, the electronic wallet 102 further comprises a plurality of components embedded in the electronic wallet 102. The plurality of components, either alone or in combination, facilitate(s) to prevent the electronic wallet 102 from theft or thereby misuse of the financial instrument present in the electronic wallet 102. In one aspect, the plurality of components may include, but not limited to, a Subscriber Identity Module (SIM) card 302, a battery 304, a Global Positioning System (GPS) 306, a wireless communication means 308, demagnetization means 310, and a scanner 312.

In order to establish a communication channel, the electronic wallet 102 comprises the SIM card 302 for establishing the communication channel with the centralized server 104 by virtue of the SIM card 302. The electronic wallet 102 further comprises the GPS 306 that facilitates to track the Geo-Location coordinates of the electronic wallet 102 in case of theft. The electronic wallet 102 further comprises the wireless communication means 308 for communicating with the communication device 112 over near Personal Area Network (PAN) protocols like Bluetooth™. In one aspect, the electronic wallet 102 may be paired with the communication device 112 using Bluetooth™. Examples of the communication device 112 may include, but not limited to, a smart band, a smart watch, a smart phone, a portable computer, a personal digital assistant, a handheld device, and a workstation.

In one embodiment, when the pairing of the electronic wallet 102 and the communication device 112 is unpaired due to non-presence of the owner, wearing the smart watch, within a predefined range of the electronic wallet 102, then the owner may be notified on the communication device 112. It may be understood that the notification indicates that the owner goes beyond the predefined range from the electronic wallet 102 thereby alerting to the owner to prevent the electronic wallet 102 from theft or misplacing. In one aspect, the pairing further facilitates to an alternate method for authenticating the owner whereby the owner needs to input preconfigured key from the communication device's 112 Graphical User Interface (GUI) for successful authentication.

The electronic wallet 102 further comprises the demagnetization means 310. In one aspect, the demagnetization means 310 may include a demagnetizing strip 310-1 and a beating coil 310-2. It may be understood that the demagnetization means 310, embedded in the electronic wallet 102, demagnetizes a strip of a financial instrument present in the electronic wallet 102. In one embodiment, the demagnetization means 310 demagnetizes the strip based upon occurrence of at least one of predefined events thereby rendering the financial instrument useless in order to avoid misuse of the financial instrument present in the electronic wallet 102. The predefined events may include, but not limited to, the electronic wallet 102 is not within a predefined range of the communication device 112 and the electronic wallet 102 is not within the predefined range for more than a predefined time period.

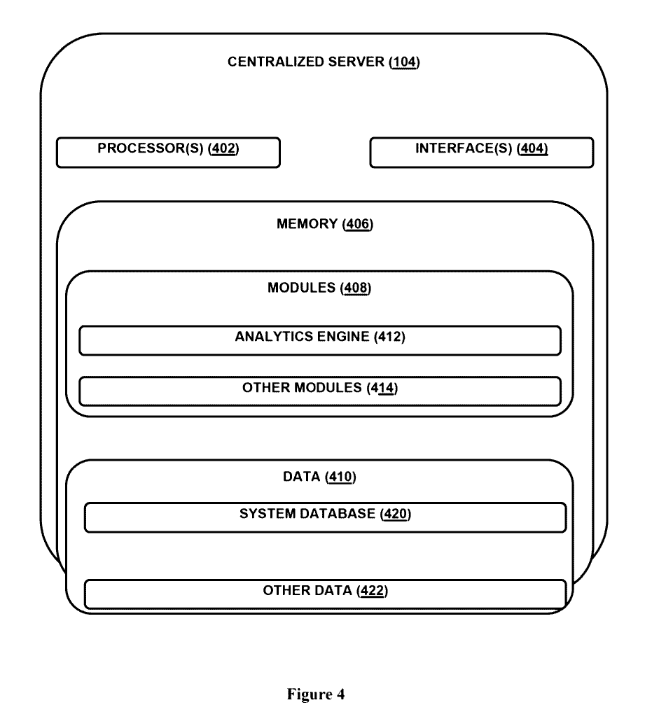

The electronic wallet 102 further comprises the scanner 310 for scanning one or more currency notes inserted or withdrawn from the electronic wallet 102. In one aspect, the scanner 310 scans the one or more currency notes for determining an amount of the one or more currency notes present in the electronic wallet 102. Upon determination of the one or more currency notes, the amount may be transmitted to the analytics engine 412 present in the centralized server 104. In one embodiment, upon determining the amount, an analytics engine 412, illustrated in FIG. 4, analyses the spending pattern of the owner based on the one or more currency notes inserted or withdrawn from the electronic wallet 102. The detail functioning of the analytics engine 412 is described below.

In one embodiment, the centralized server 104 is illustrated in FIG. 4, in accordance with an embodiment of the present subject matter. In one embodiment, the centralized server 104 may include at least one processor 402, an input/output (I/O) interface 404, and a memory 406. The at least one processor 402 may be implemented as one or more microprocessors, microcomputers, microcontrollers, digital signal processors, central processing units, state machines, logic circuitries, and/or any devices that manipulate signals based on operational instructions. Among other capabilities, the at least one processor 402 is configured to fetch and execute computer-readable instructions stored in the memory 406.

The I/O interface 404 may include a variety of software and hardware interfaces, for example, a web interface, a graphical user interface, and the like. The I/O interface 404 may enable the centralized server 104 to communicate with other computing devices, such as web servers and external data servers (not shown). The I/O interface 404 can facilitate multiple communications within a wide variety of networks and protocol types, including wired networks, for example, LAN, cable, etc., and wireless networks, such as WLAN, cellular, or satellite. The I/O interface 404 may include one or more ports for connecting a number of devices to one another or to another server.

The memory 406 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 406 may include modules 408 and data 410.

The modules 408 include routines, programs, objects, components, data structures, etc., which perform particular tasks or implement particular abstract data types. In one implementation, the modules 408 may include an analytics engine 412 and other modules 414. The other modules 414 may include programs or coded instructions that supplement applications and functions of the system 102. The modules 408 described herein may be implemented as software modules that may be executed in the cloud-based computing environment of the centralized server 104.

The data 410, amongst other things, serves as a repository for storing data processed, received, and generated by one or more of the modules 408. The data 410 may also include a system database 420 and other data 422. The other data 422 may include data generated as a result of the execution of one or more modules in the other modules 414.

In one implementation, the analytics engine 412 may be configured to monitor spending pattern of the owner based on the one or more currency notes inserted or withdrawn from the electronic wallet 102. In one aspect, the analytics engine 413 monitors the spending pattern in order to notify, via the communication device, the owner to withdraw an amount from the financial institution when the amount, of the one or more currency notes, is less than a predefined threshold amount. It may be understood that the owner may be notified upon performing the analysis on historical data comprising the spending pattern, along with other data comprising GPS location from where the owner inserts or withdraws the amount from the electronic wallet 102, presence of the financial institution within a predefined range of the owner. In one aspect, the historical data may be stored in the system database 420. In addition to the above, the analytics engine 412 may also take into consideration other data that may include, but not limited to, cost of living, average expenses while performing the analysis.

In order to elucidate further consider an example where the owner carrying the electronic wallet 102 contains the amount less than the predefined threshold amount. In such a scenario, when the owner appears within the predefined range of the financial institution, the owner is notified to withdraw the amount from the financial institution such as ATM or bank. Thus, based on the analysis performed on the aforementioned data, the analytics engine facilitates to notify the owner when the amount present in the electronic wallet 102 is less than the predefine threshold amount.

In one embodiment, the spending pattern and the analysis performed on the historical data by the analytics engine 412 may further be utilized, by the advertisement agencies for providing person specific behavior campaigning for effective advertising. This may help the advertisement agencies for rolling out contextual promotions based on users' need for effective advertising.

Exemplary embodiments discussed above may provide certain advantages. Though not required to practice aspects of the disclosure, these advantages may include those provided by the following features.

Some embodiments of the electronic wallet enables to predict consumer spending behavior by running analytics on data associated to the electronic wallet.

Some embodiments of the electronic wallet enables to authenticate the electronic wallet using biometric sensor thereby prevents unauthorized access to the electronic wallet.

Some embodiments of the electronic wallet enable to demagnetize a strip of the financial instrument upon applying heat so as to render the financial instrument useless.

Some embodiments of the electronic wallet enable to notify the issuer of the financial instrument for blocking the financial instrument on occurrence of at least one of predefined events.

Some embodiments of the electronic wallet enable to send biometric data of the unauthorized owner (along with the location information) to law enforcement agencies for taking precautionary measures in case of theft of the electronic wallet.

Some embodiments of the electronic wallet enable to notify, an the communication device paired with the electronic wallet, the owner in case of communication is lost between the communication device and the electronic wallet.

Although implementations for electronic wallet 102 have been described in language specific to structural features and/or methods, it is to be understood that the appended claims are not necessarily limited to the specific features or methods described. Rather, the specific features and methods are disclosed as examples of implementations for the electronic wallet 102.

We claim:

1. An electronic wallet comprising:
a biometric authentication module for authenticating an owner of the electronic wallet, wherein the owner is authenticated b verifying authentication credentials received from the owner, wherein the authentication credentials are verified by a centralized server communicatively coupled with the electronic wallet;
a scanner configured to scan one or more currency notes inserted or withdrawn for determining an amount of the one or more currency notes present in the electronic wallet;
a wireless communication means for establishing a communication channel between the electronic wallet and a communication device, wherein the communication channel is established in order to notify the owner, on the communication device, based upon occurrence of at least one of predefined events; and
a demagnetization means for demagnetizing a strip of a financial instrument present in the electronic wallet based upon occurrence of at least one of the predefined events thereby rendering the financial instrument useless in order to avoid misuse of the electronic wallet.

2. The electronic wallet of claim 1, wherein the communication device is at least one of a smart watch, a smart band, or a smart communication device.

3. The electronic wallet of claim 1 further comprises a finger print sensor, a retina sensor, a heartbeat sensor, and an image capturing unit for authenticating the owner of the electronic wallet.

4. The electronic wallet of claim 1, wherein the centralized server comprises an analytics engine, wherein the analytics engine monitors spending pattern of the owner based on the one or more currency notes inserted or withdrawn from the electronic wallet.

5. The electronic wallet of claim 4, wherein the analytics engine further performs analysis on historical data, comprising the spending pattern, along with other data comprising GPS location of the owner, financial institution within a predefined range of the owner.

6. The electronic wallet of claim 5, wherein the owner is further notified to withdraw an amount, via the communication device, from the financial institution when the amount of the one or more currency notes is less than a predefined threshold amount, and wherein the owner is notified based on the analysis performed by the analytics engine.

7. The electronic wallet of claim 1, wherein the centralized server is configured to transmit a notification to at least one of a first server and a second server, and wherein the first server belongs to an issuer of the financial instrument, and wherein the second server belongs to a law enforcing agency, and wherein the centralized server is communicatively coupled with the first server and the second server.

8. The electronic wallet of claim 1, wherein the predefined events comprise the electronic wallet is not within a predefined range of the communication device, the electronic wallet is not within the predefined range for more than a predefined time period, and the amount is less than the predefined threshold amount.
